(19) United States
(12) Patent Application Publication
(10) Pub. No.: US 2012/0046958 A1
(43) Pub. Date: Feb. 23, 2012

(54) SYSTEMS AND METHODS FOR PROVIDING A MULTI-CHANNEL RETAIL LAYAWAY SERVICE

(75) Inventors: Seby Paul Pynadath, Bartlett, IL (US); Marie Mills, Chicago, IL (US)

(73) Assignee: SEARS BRANDS, LLC, Hoffman Estates, IL (US)

(21) Appl. No.: 12/859,625

(22) Filed: Aug. 19, 2010

(51) Int. Cl. G06Q 30/00; G06Q 10/00

(52) U.S. Cl. 705/1.1

(57) ABSTRACT

Multi-channel layaway services are provided whereby a customer may use an online retail channel or a physical retail channel to form a layaway contract to purchase one or more ordered items and then use the online retail channel and/or the physical retail channel to make payments on, view, or otherwise manage the formed layaway contract. Upon completion of the terms of the formed layaway contract the customer is able to receive the ordered items.

### BACKGROUND

The subject invention generally relates to computer-based retail services and, more particularly, relates to systems and method for providing a multi-channel retail layaway service.

In the art, system and methods for providing retail layaway services are generally known. By way of example, eLayaway, Inc. provides a retail layaway service that, like traditional retail layaway services, allows a customer to make payments over time for items ordered online from a merchant. The customer can interact with an online calculator to customize the size of the monthly payments by adjusting how many payments are desired. The system then functions to automatically deduct the monthly payments from a specified bank account. When all of the payments have been made, the merchant will ship the items ordered to the customer.

### SUMMARY

The following describes systems and methods for providing a multi-channel retail layaway service, i.e., a retail layaway service to which online retail channels and physical or “brick and mortar” retail channels are both linked. The described systems and methods thus allow a customer to use the online retail channel or the physical retail channel to form a layaway contract to purchase one or more ordered items (which ordered items may then be placed in holding stock, for example, at a retail store location), use the online retail channel and/or the physical retail channel to make payments on, view, or otherwise manage the formed layaway contract, and ultimately receive the ordered items upon completion of the terms of the formed layaway contract (for example, at the retail store location at which such ordered items were held in stock).

While the forgoing provides a general overview of some of the various features and functionalities of the subject invention, a better understanding of the objects, advantages, features, properties and relationships of the subject invention will be obtained from the following detailed description and accompanying drawings which set forth illustrative embodiments and which are indicative of the various ways in which the principles of the subject invention may be employed.

### BRIEF DESCRIPTION OF THE DRAWINGS

For a better understanding of the subject invention, reference may be had to preferred embodiments shown in the attached drawings in which:

FIG. 1 illustrates in block diagram form components of an exemplary retail environment in which the principles of the subject invention may be employed;

FIG. 2 illustrates in block diagram form components of an exemplary host system of FIG. 1;

FIG. 3 illustrates a flow diagram of exemplary methods for forming a retail layaway contract via the retail environment of FIG. 1;

FIG. 4 illustrates a flow diagram of exemplary methods for making payments on the formed layaway contract via the retail environment of FIG. 1; and

FIG. 5 illustrates a flow diagram of exemplary methods for completing the formed layaway contract with a final payment via the retail environment of FIG. 1.

### DETAILED DESCRIPTION

With reference to the figures, the following describes various systems and methods for linking both online retail channels and physical or “brick and mortar” retail channels with a retail layaway service. In this manner a customer can use the online retail channel or the physical retail channel to form a layaway contract to purchase one or more ordered items (which ordered items may then be placed in holding stock, for example, at a retail store location), use the online retail channel and/or the physical retail channel to make payments on, view, or otherwise manage the formed layaway contract, and ultimately receive the ordered items upon completion of the terms of the formed layaway contract (for example, at the retail store location at which such ordered items were held in stock).

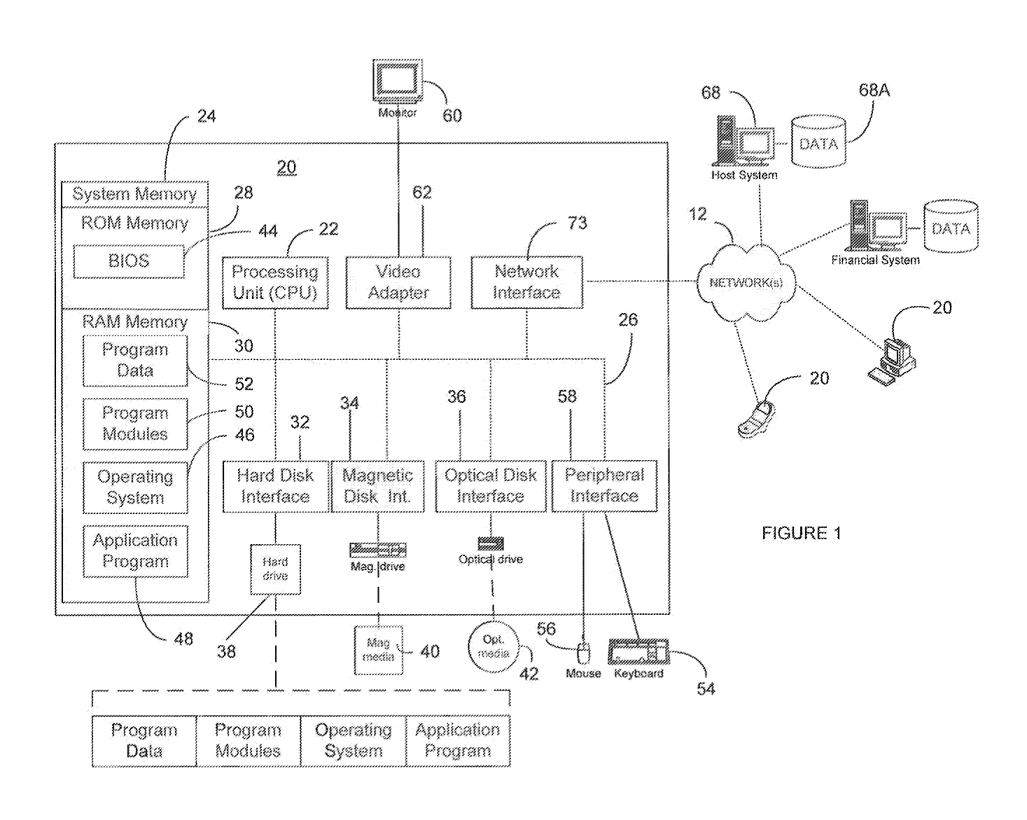

Turning now to FIG. 1, a processing device 20 is provided whereby a customer may access an online retail channel hosted by one or more host systems 68 to, among other things, view and order products and/or services, i.e., “items,” being offered for sale online, to access and interact with a centralized layaway contract management system supported by the host system(s) 68, etc. While illustrated in the exemplary form of a personal computer, it is to be understood that the processing device 20 may be embodied in any type of device having the ability to execute instructions such as, by way of example only, a personal-digital assistant (“PDA”), a cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network, such as the Internet, whereby the executable instructions may be associated with and/or executed by one or more of the multiple processing devices.

More particularly, to provide a means for the customer to access the online retail channel (and to perform various other tasks as necessary) the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated physically embodied computer-readable media allow for the storage of instructions, data structures, program modules, and the like for execution by the processing unit 22 of the processing device 20. Those skilled in the art will further appreciate that other types of physically embodied computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories. Meanwhile, the program modules that may be stored in one or more of the memory/media devices may include a basic input/output system (BIOS) 44 which contains the basic routines that help to transfer information between elements within the processing device 20, such as during start-up, an operating system 46, one or more applications programs 48 (such as a Web browser), other program modules 50, and/or program data 52.

To allow a user to enter commands and information into the processing device 20, input devices such as a touch pad or keyboard 54 and/or a pointing device 56 are provided. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

As noted above, the processing device 20 may also utilize logical connections to one or more remote processing devices, such as a host system 68 having associated data repository 68A. While the host system 68 has been illustrated in the exemplary form of a server computer, it will be appreciated that the host system 68 may, like processing device 20, be any type of device having processing capabilities. Similarly, it will be appreciated that the host system 68 need not be implemented as a single device but may be implemented in a manner such that the tasks performed by the host system 68 are distributed amongst a plurality of processing devices/databases located at the same or different geographical locations and linked through a communication network. Additionally, the host system 68 may have logical connections to other third party systems via the network 12 and, via such connections, will be associated with functions that are supported by and data repositories that are linked to such other third party systems. Such third party systems may include, without limitation, systems of banking, credit, or other financial institutions, systems of third party providers of goods and/or services, systems of shipping/delivery companies, systems that support social networking, etc.

For performing tasks as needed, the host system 68 may include many or all of the elements described above relative to the processing device 20. In addition, the host system 68 would generally include executable instructions that are likewise stored on physically embodied memory devices for, among other things, providing online retail channel services, providing physical retail channel services, managing item orders, shipment, storage, managing retail layaway contracts, and/or managing financial accounts. To this end, the host system 68 may additionally include point-of-sale devices, e.g., cash registers, that are located within retail stores, mobile devices (e.g., to be used in a retail store by associates to pick items for layaway storage), informational kiosks, wireless access points, and the like without limitation.

Communications between the processing device 20 and the host system 68 may be exchanged via a further processing device, such as a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) associated with the host system 68.

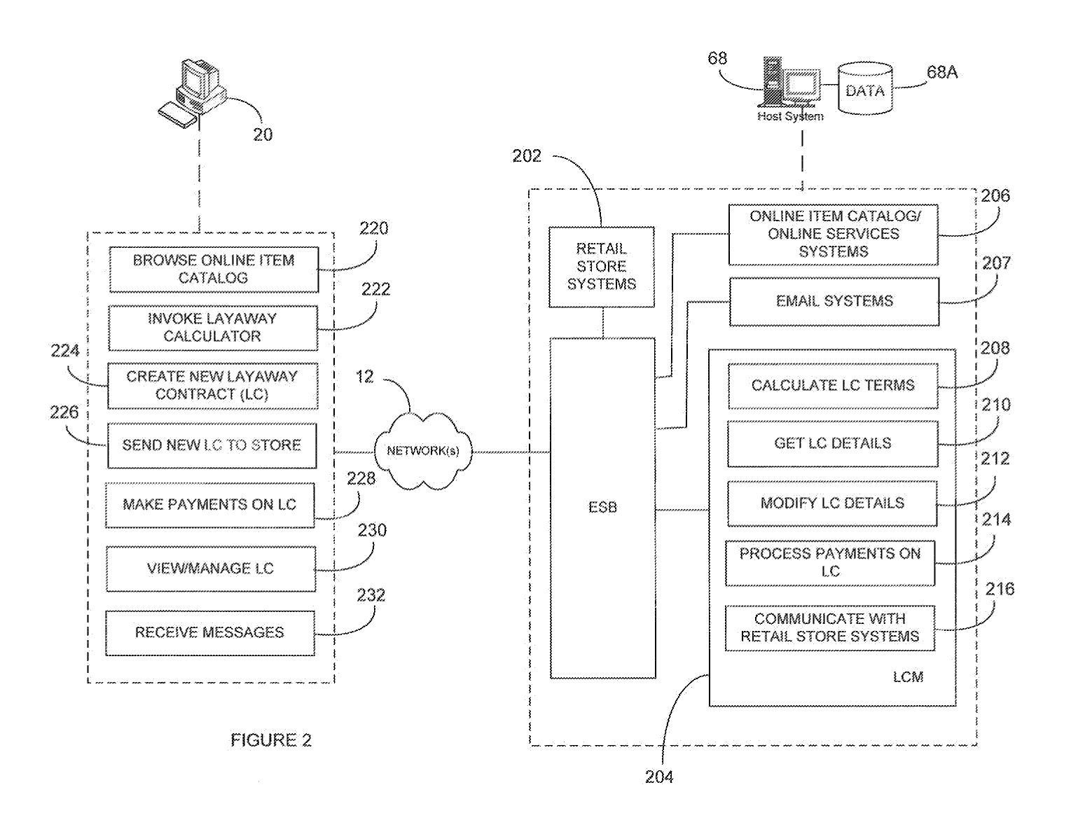

As noted above, the subject invention, particularly the host system 68, provides a multi-channel retail layaway service wherein online retail channels and physical or “brick and mortar” retail channels are linked. As particularly illustrated in FIG. 2, for this purpose the host system 68 includes an enterprise service bus (ESB) 200 that functions to manage communications between the various host system components including the system components that are located in the physical retail store 202 (such as point-of-sale devices, in-store kiosks, associate hand-held communication devices, etc.), the system components that comprise a layaway contracts management system (LCM) 204, the system components that are used to provide online retail or “.com” services 206, email system components 207, etc. as well as with processing devices 20. By way of example only and without limitation, the

LCM 204 may include executable instructions for calculating terms/payments for a proposed retail layaway contract 208, for retrieving details of a formed retail layaway contract 210 (e.g., for provision to retail store systems or processing device 20), for modifying, managing, and monitoring details of a formed retail layaway contract 212, for processing payments made on a formed retail layaway contract 214 (which may interact with third party financial systems and/or financial systems of the retailer), for communicating information to/receiving information from retail store system components 216 (e.g., for receiving information for a retail layaway contract being formed in a physical retail store, for informing a retail store that layaway items are to be placed on hold, etc.), for causing the mail system components to send notifications to processing device 20, and the like. As a result of such executable instructions, the host system 68 provides mechanisms whereby a consumer may, again by way of example only and without limitation, browse online item catalogs as well as access additional online retail services 220, invoke a retail layaway calculator 222 (e.g., to view and optionally determine payments for items that may be desired to be purchased via layaway), enter into a retail layaway contract 224 and 226, cause payments to be made on a formed layaway contract 228 (which may involve communications being exchanged with third party financial systems), view and manage a formed layaway contract 230, receive email status/reminder communications from the host system 68, etc.

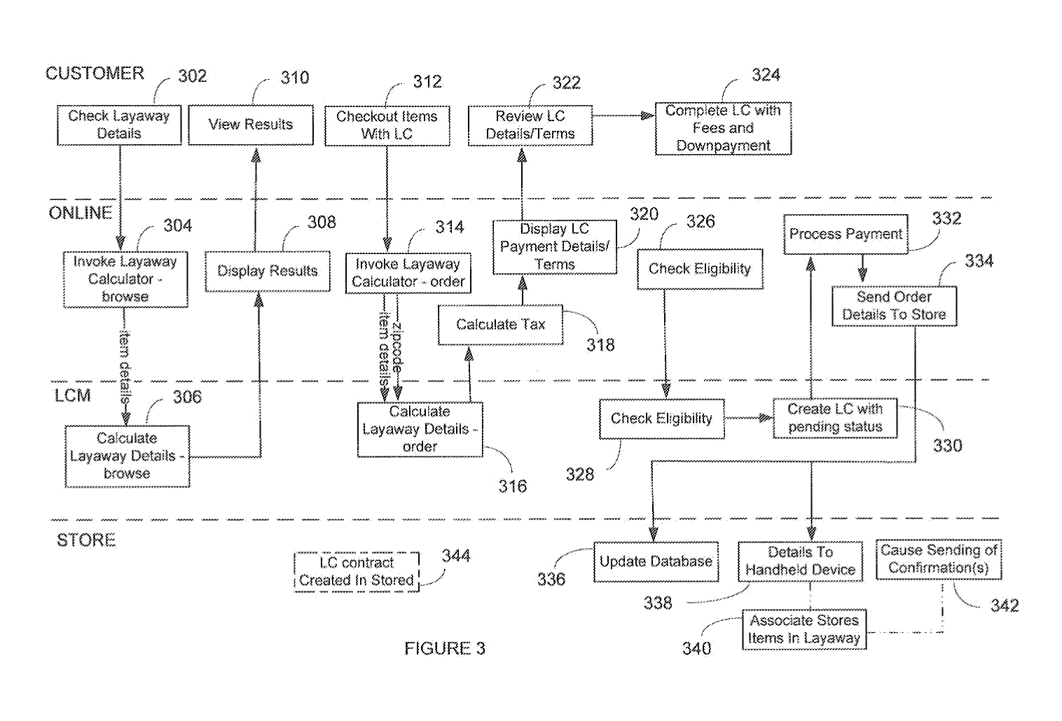

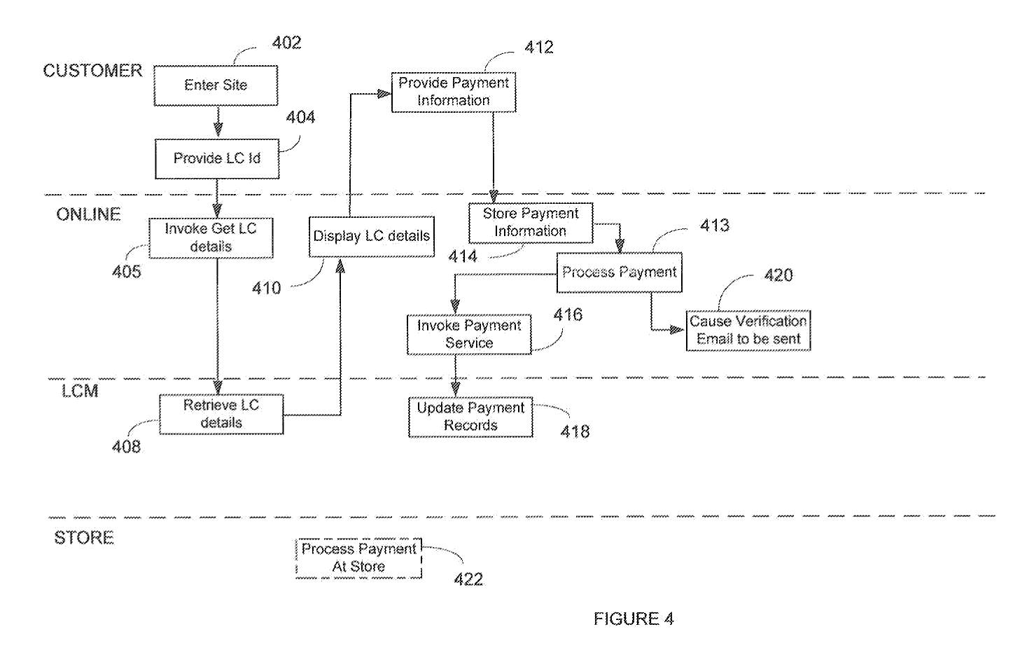

By way of further example with reference to FIGS. 3-5, via the online retail channel a customer may browse an online catalog of a retailer and from an item detail page, shopping cart checkout page, search results page, etc., cause a request 302 to be issued to the host system 68, for example by activation of a hyperlink, icon, or the like, for the purpose of notifying the host system 68 that the customer would like to see layaway purchasing details for one or more items. It is to be appreciated that the retailer need not provide a layaway purchasing option for all items that are being sold and, as such, the retailer may selectively provide a layaway purchasing option for an item. By way of example only, an item may be eligible for layaway purchasing depending upon factors such as the stock status of the item, seasonal status of the item, or the like. In response to the request 302, the online system component 206 of the host system will invoke 304 a layaway calculator component that is provided by the LCM 204 whereupon the layaway calculator component will function 306 to generally determine or estimate for an indicated item or items the details that would be applicable to a layaway contract to purchase the item or items. These details would typically include payment amounts that would need to be made over given periods of time, such as weekly, monthly, etc., to thereby purchase the indicated item by a given end date via the layaway purchase option. The details determined by the calculator are then returned to the online system component 206 whereupon the online system component 206 will cause the details to be displayed 308 for viewing 310 by the customer. During this process, it will be appreciated that the host system 68 may optionally provide for the customer to interact with a presented layaway calculator interface to thereby dynamically change one or more layaway conditions, e.g., length of contract, payment intervals, location where items are to be picked up, etc, and to thereby view how the layaway details, as determined by the calculator, are changed as the layaway conditions are changed by the customer.

In the event that the customer thereafter elects to order one or more items using the layaway purchase option 312, for example by again selecting a hyperlink, icon, or the like presented on a product detail page, shopping cart checkout page, search results page, with the layaway calculator interface, etc., the online system component 206 will again invoke 314 the layaway calculator component that is provided by the LCM 204 whereupon the layaway calculator component will function 316 to determine for an indicated item or items the details that will be applicable to a layaway contract that is to be created pending a later check of customer and/or item eligibility, e.g., a check to determine if customer payment information is correct and/or item(s) ordered are in stock. As before, the details for the layaway contract would include the payment amounts that would need to be made over given periods of time, such as weekly, monthly, etc., to thereby purchase the indicated item or items by a given end date via the layaway purchase option. The details determined by the calculator for the layaway contract are then returned to the online system component 206 whereupon the online system component 206 will additionally calculate 318 a tax owed on the purchase, for example, by considering the zipcode which an item is be picked up at or delivered to upon completion of the layaway contract. The online system component 206 may again cause the details associated with the layaway contract to be displayed 320 for viewing, optional modification, and acceptance 322 by the customer.

Upon the customer indicating an acceptance of the currently presented terms of the layaway contract 324 and providing any initial payment fees if required, the host system 68 will proceed to check 326/328 the eligibility of the pending layaway contract 330. In this regard, the host system 68 may perform post order processing to secure payment authorization (which may require an exchange of communications with a third party financial system) and to ensure that the item or items that are the subject of the pending layaway contract are in stock in the required quantities. In the event that all requested item(s) or quant(ies) of item(s) are not available, e.g., not at a retail store selected by the customer for pickup upon completion of the terms of the layaway contract, the customer may be notified, for example via an email sent using email systems 207, whereupon the customer may access the host system 68 via the online retail channel (or via the physical retail channel with a visit to a retail store) to modify the details of the pending layaway contract, e.g., to cancel the pending layaway contract or to remove or reduce quantity of items present in the pending layaway contract. A pending layaway contract modified in this manner would cause the details for the pending layaway contract to be updated in the LCM 204 and would cause the performance of further action as necessary, e.g., to again check details of the contract with store inventory. If a customer does not modify a pending layaway contract wherein all requested item(s) or quant(ies) of item(s) are not available with a specified period of time or otherwise make any required fee payments in the event that payment authorization was not received, the host system 68 may function to automatically cancel the pending layaway contract whereupon the customer will be so notified, for example via an email sent using the email systems 207, and the LCM 204 updated with the details for the canceled layaway contract. A retail store may also be notified of such a cancellation event if necessary to allow the retail store to remove any reserved layaway items from layaway storage.

When the eligibility of a created, pending layaway contract is confirmed and an initial payment thereon appropriately processed 332, a retail store which was selected by the customer or otherwise determined to be a pickup location can be provided 334 with the details of the pending layaway contract whereupon that retail store can update its inventory database 336 and cause the quantity of item or items ordered to be placed into layaway holding storage. To this end, the host system 68 may cause a notification event to be sent 338 to a handheld device that is provided to an associate of the retail store whereupon the retail store associate will proceed 340 to collect the quantity of item or items that are the subject of the pending layaway contract and place the same into layaway holding storage at the retail location. When the quantity of item or items have been accordingly placed into layaway holding storage, the retail store associate may use the handheld device to cause a confirmation 342 of the perfected layaway holding to be sent to the LCM 204, the store inventory database, and the customer via the host system 68 email system components 207.

While the foregoing describes an example by which the online retail channel may be used to create, modify, and manage a pending layaway contract, it is to be appreciated that similar steps 344 may be performed in a retail store, i.e., the physical retail channel, with, for example, a customer interacting with a retail store associate. In this regard, the retail store associate may use a retail store computer, point-of-sale device, or the like to access the layaway calculator and other component of the LCM 204 and, with the customer, view, modify, create, and accept a pending layaway contract, collect any fees or downpayment (which may be tendered in cash in this case), commence eligibility checking, cause the ordered quantity of item(s) to be placed into layaway storage, etc. It will be appreciated that, in this case the retail store associate would also obtain from the customer online contact information, such as an email address, whereby the host system 68 can provide the customer with details concerning the pending layaway contract formed via the physical retail channel and whereby the customer can view, modify, make payments on, or otherwise manage the pending layaway contract formed via the physical retail channel via use of the online retail channel.

To make payments on a pending layaway contract via the online retail channel in accordance with the terms of the pending layaway contract, the host system 68 may be accessed by a customer 402 whereupon the customer will provide 404 the host system 68 with an ID that corresponds to the pending layaway contract that is of interest to the customer. The ID can be a layaway contract ID that was associated with the pending layaway contract when the pending layaway contract was created by the LCM 204. In this regard, it will be understood that the ID associated with a pending layaway contract may be provided to a customer through use of email notifications or may be otherwise provided to the customer via a webpage when the customer is known to the host system 68, for example by means of a system login or the like. It will also be appreciated that the ID can be provided to the host system 68 through use of a free-form text entry box, by clicking on a link displayed on a webpage, or the like. Once the host system 68 is provided with the ID corresponding to a pending layaway contract of interest to the customer, the host system 68 will proceed to request 405 that the LCM retrieve 406 the details of the pending layaway contract whereupon the details of the pending layaway contract are caused to be displayed 408 to the customer at their corresponding processing device 20. By means of otherwise conventional user interface elements, the customer may then elect to cause 410 an online initiated payment to be made on the pending layaway contract whereupon the payment information will be provided 412 to the host system 68 for processing 413 (which may involve an exchange of communications with a third party financial system).

In the event that the payment is successfully processed, the system will initiate 416 an update to the pending layaway contract 418 at the LCM 204 and cause a verification of the accepted payment 420 to be sent to the customer, for example via use of the email system components 207. If, however, the payment is not successfully processed, the system may optionally give the customer a time in which to cure the missed payment and, if not cured, may then function to automatically cancel the pending layaway contract with notification being provided to the customer, with LCM records being updated, and previously paid amounts (if any) being appropriately processed. To assist the customer in timely making payment, it will be appreciated that the host system 68 may function to send reminders to the customer as necessary.

As before, it is to be understood that similar payment related steps 422 may be performed in a retail store, i.e., the physical retail channel, with, for example, a retail store associate using a retail store computer, point-of-sale device, or the like to access a pending layaway contract of interest and process a payment (which may be tendered in cash) against the pending layaway contract. Any payment so made at the retail store will be reflected in the records of the pending layaway contract that are maintained by the LCM 204, as is the same for a payment made via the online retail channel.

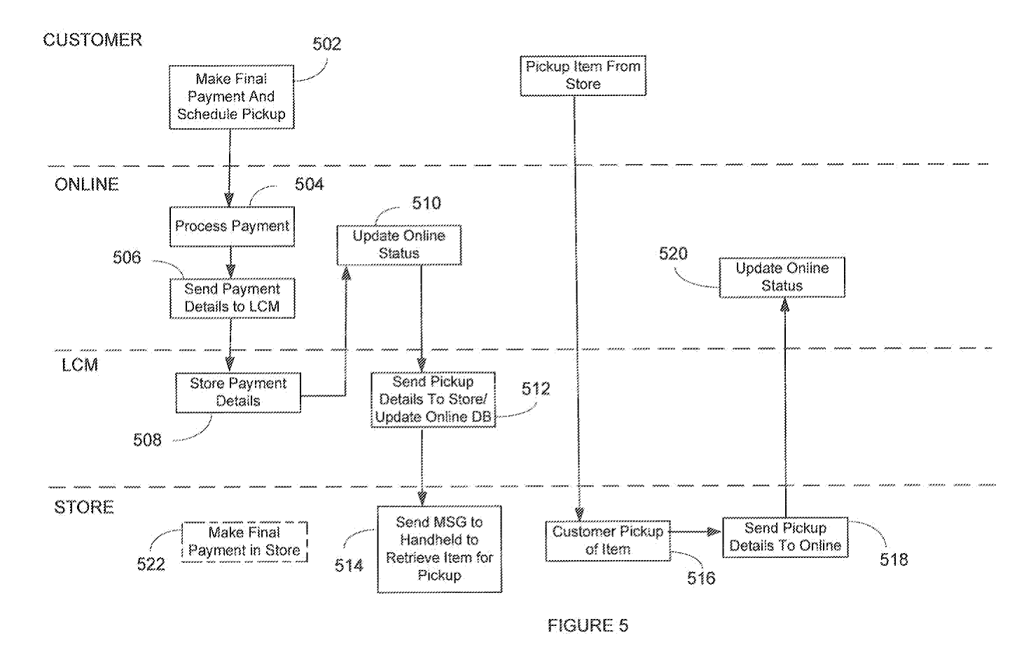

Turning now to FIG. 5, when a final payment 502 is made via the online retail channel on a pending layaway contract the payment will be processed 504 as described above, e.g., payment may be verified via an exchange of communications with a third party financial system. At this time, however, the customer may also interact with the host system 68 to schedule, via a provided user interface, a time at which the user would desire to pickup the order item or items at the retail store in which they were held in layaway storage. In the case where the final payment is not successfully processed, the host system 68 may, as before, notify the customer and request that proper payment be made or otherwise cancel the pending layaway contract. In the case where the final pay is successfully processed, the payment and pickup details would then be sent 506 to the LCM 204 whereupon the layaway contract status would be updated 508 (which status 510 may also be updated with the online systems accessible to the consumer) and the store notified 512 of the pickup details. In this regard, the pickup details can be sent 514 to a handheld device of an associated at the retail store to thereby notify the associate that the item or items have to be retrieved from layaway storage. At this time, a confirmation message may also be sent to the customer, for example via an email sent using the email systems 207. The customer 516 may then proceed to pickup the item or items at the retail store as scheduled after which the pickup details will be sent to 518 and thereafter registered 520 with the host system 68 thus completing fulfillment of the layaway contract. As will be appreciated, in an alternative embodiment, the customer may arrange to have item or items shipped to a given destination in lieu of scheduling pickup. It will also be appreciated that similar final payment related steps 522 may be performed in a retail store, i.e., the physical retail channel, with, for example, a retail store associate using a retail store computer, point-of-sale device, or the like to access a pending layaway contract of interest and to process a final payment (which may be tendered in cash) against the pending layaway contract. Any payment so made at the retail store will be reflected in the records of the pending layaway contract that are maintained by the LCM 204, as is the same for a payment made via the online retail channel and the item or items order will be retrieved for the customer.

While various concepts have been described in detail, it will be appreciated by those skilled in the art that various modifications and alternatives to those concepts could be developed in light of the overall teachings of the disclosure. For example, those of skill in the art will appreciate that the ordering of the steps described herein and illustrated in the figures can be modified without departing from the scope of the invention claimed hereinafter. Similarly, those of skill the art will appreciate that certain of the steps described herein may be considered to be optional. Yet further, while various aspects of the invention have been described in the context of functional modules and components, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of the modules used to perform the various described functions is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person knowledgeable in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

What is claimed is:

1. A computer readable media in the form of a physical memory device having stored thereon computer executable instructions for providing a multi-channel layaway service, the instructions performing steps, comprising:
creating in a centralized layaway contract management system from information received via one of an online retail channel and a physical retail channel a layaway contract to purchase one or more ordered items;
allowing the status of the layaway contract in the centralized layaway contract management system to be updated in response to payments made against the layaway contract via both the online retail channel and the physical retail channel; and
in response to a final payment being made against the layaway contract, causing the centralized layaway contract management system to issue a release of the one or more ordered items.

2. The computer readable media as recited in claim 1, wherein the centralized layaway contract management system causes a notification to be sent to a handheld device of an associate of a retail location and wherein the notification comprises details for allowing the associate to place the one or more ordered items in layaway storage at the retail location.

3. The computer readable media as recited in claim 1, wherein the issued release of the one or more ordered items comprises details associated with a scheduled pickup of the one or more items at a retail location.

4. The computer readable media as recited in claim 1, wherein the issued release of the one or more ordered items comprises details associated with a delivery of the one or more items to a customer.

5. The computer readable media as recited in claim 1, wherein the centralized layaway contract management system associates an identifier with the layaway contract whereby details of the layaway contract are accessible via both the online retail channel and the physical retail channel.

6. The computer readable media as recited in claim 1, wherein the centralized layaway contract management system communicates with a retail store system to determine if the one or more items are available for layaway before finalizing the layaway contract.

7. The computer readable media as recited in claim 1, wherein the centralized layaway contract management system provides a calculator for presenting to a customer details associated with the layaway contract prior to creation of the layaway contract.

8. The computer readable media as recited in claim 7, wherein the centralized layaway contract management system provides a user interface whereby details associated with the layaway contract are modifiable by the customer prior to creation of the layaway contract.
